(19) United States
(12) Patent Application Publication
(10) Pub. No.: US 2013/0237749 A1
(43) Pub. Date: Sep. 12, 2013

(54) STIMULATOR FOR ORAL SEX

(71) Applicants: Kin Wai LEE, Hong Kong (HK); Chun Yin Cheung, Belfast (GB)

(72) Inventors: Kin Wai LEE, Hong Kong (HK); Chun Yin Cheung, Belfast (GB)

(21) Appl. No.: 13/416,528

(22) Filed: Mar. 9, 2012

(51) Int. Cl. A61H 19/00

(52) U.S. Cl. 600/38

(57) ABSTRACT

A sexual stimulator for oral sex is disclosed that includes a body and a motor. The body forms a clipping structure which can be clipped onto and worn on a mouth such that a fore part of the body is snug inside a wall of the mouth while the rear part of the body will snug the exterior face. The stimulator facilitates the user to clip, wear and take off the stimulator and a micro-circuit control chip controls an output of a motor for different modes of vibration. In addition, the overall small size only occupies a little space within the mouth cavity without affecting the motions in the course of oral sex.

### BACKGROUND OF THE INVENTION

1. Field of the Invention

The present invention relates to a stimulator for oral sex.

2. Description of the Background Art

Abundant electronic sexual stimulators are found in the market for adult's toys, such as vibrators and simulation toys, etc. These products usually need to be grabbed by hand or strapped. Only few adult's toys can be worn on the mouth in the course of oral sex, for example, a soft rubber teeth brace.

U.S. Pat. No. 6,645,164 discloses a vibrating oral sex enhancement device, and U.S. Pat. No. 6,244,269 discloses a two piece mouthpiece to be worn by consenting adults performing oral sexual activities.

The convention art, however, has apparent defects, in that they needs to be grabbed by hands so that the user cannot use their hand to make other motions, and they are inconvenient even though they can be worn on the mouth.

### SUMMARY OF THE INVENTION

It is therefore an object of the present invention to provide a stimulating device for oral sex which brings along an innovative way for oral sex.

The present invention is a stimulating device for oral sex. In an embodiment, the device includes a body containing an electrically powered motor and a controller. In an embodiment, the body forms a clipping structure to be clipped onto and worn on the mouth. The fore part of the body can be put inside the mouth to snug, i.e., fit closely to, the wall of a mouth cavity while the rear part of the body will snug the exterior face. When the fore part of this invention is put inside the mouth, its small figure allows normal oral sex activities without affecting other motions.

The body can be in a “U” shape. The fore part and rear part are joined by a “U shape junction”, the radian of which is capable of forming a clipping effect so that it can be clipped onto and worn on the mouth.

The body can be in a “J” shape. The fore part and rear part are joined by a “U shape junction”, the radian of which is capable of forming a clipping effect so that it can be clipped onto and worn on the mouth.

The head of the fore part of the body can be in an oval shape. One of its sides can be relatively flat in shape, which becomes incrementally narrower and extends to the “U shape junction”. The shape and structure of the stimulator suit the facial structure of human body better.

The rear part of the body can be formed by extending and expanding from the “U shape junction”. The shape and structure of the stimulator suit the facial structure of human body better.

The body can be hitched by medical-use soft silicone rubber hitch. Not only does it protect the mouth cavity of the user effectively, but also bring the partner a sense of comfort.

The motor can be installed in the head of the fore part of the body together with a counterweight. Not only does it utilize the internal space of the stimulator effectively so as to make the overall size even smaller, but also make this stimulator command good stability during usage at the same time so that the user will have a better experience of the vibration.

The stimulator can have batteries or rechargeable batteries as the source of power, both of which can be installed at the rear part of the body. It utilizes the internal space of the stimulator effectively so as to make the overall size even smaller.

A micro-circuit control chip can be installed at the rear part of the body. The micro-circuit control chip controls the motor to form multiple output modes of rotation so as to make the stimulator possess multiple controllable output modes of vibration capable of suiting different desire of different user.

Some of the advantages of the present invention include: (1) the design of the unique body that makes this invention snug the human face and the structure of mouth cavity even closer. It can be clipped onto the mouth conveniently and does not need to be grabbed by hand; (2) the present invention adopts plastic materials to manufacture the body thereby fully utilizing the elastic property commanded by plastic products themselves. It facilitates the user to clip, wear and take off; (3) the micro-circuit control chip controlling the output of the motor possesses multiple modes of vibration; and (4) the overall small size only occupies a little space within the mouth cavity without affecting the motions in the course of oral sex.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic diagram of the overall appearance of an embodiment of the present invention.

FIG. 2 is a schematic diagram of the disintegrated structure of the embodiment illustrated in FIG. 1.

FIG. 3 is a schematic diagram of a state of a use of the present invention.

FIG. 4 is a schematic diagram of an overall appearance of a second embodiment of the present invention.

FIG. 5 is a schematic diagram of the disintegrated structure of the second embodiment of the present invention.

### DETAILED DESCRIPTION

The figures illustrate an upper cover of the body 1; an anode metal conductor 2; a cathode metal conductor 3; a micro-circuit control chip 4; a lower cover of the body 5; a battery cover of medical-use soft silicone rubber 6; a button-shape battery 7; a motor 8; a medical-use soft silicone rubber hitch 9; a screw 10; a switch 11; a U shape junction 12; a fore part of the body 13; a head 14; a body 15; and a rear part of the body 16.

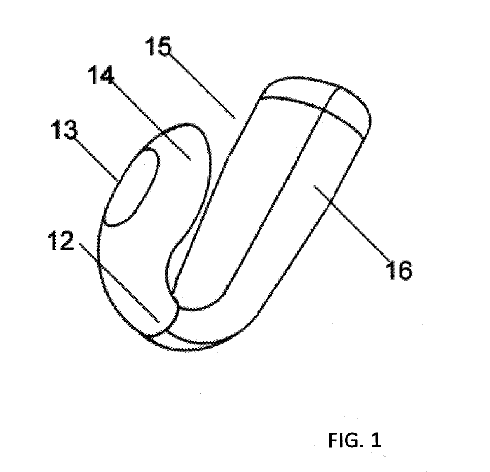

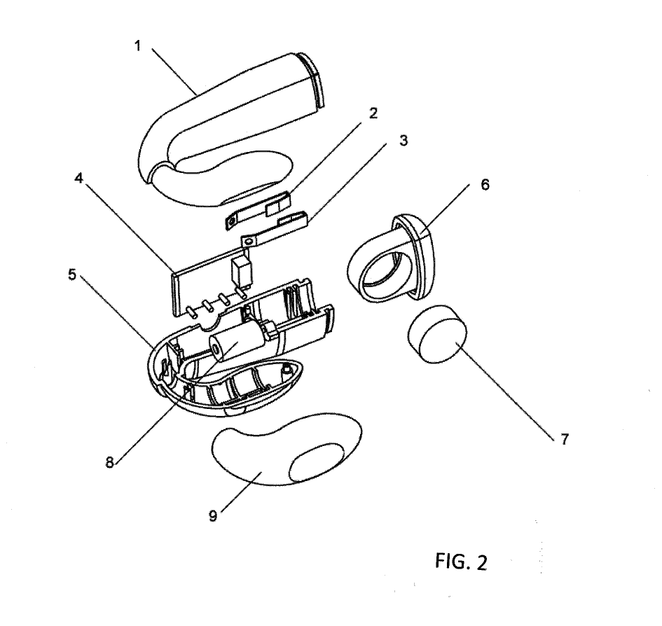

FIGS. 1 and 2 show an embodiment of the present invention, a stimulator for oral sex having the body 15 and the dc motor 8. The body is in a “J” shape which forms a clipping structure, matching the shape of a human mouth, and can be clipped onto and worn on the human mouth. The body 15 includes the fore part of the body 13 and rear part of the body 16. The fore part of the body 13 and the rear part of the body 16 are joined by a “U shape junction” 12, the radian of which is capable of forming a clipping effect so that it can be clipped onto and worn on the mouth. The body includes the upper cover 1 and the lower cover 5. Plastic materials are adopted to manufacture the body 15, thus the stimulator possesses elasticity facilitating the user to clip, wear and take off. The head 14 of the fore part of the body is in an oval shape However, one of its sides is relatively flat in shape, which becomes incrementally narrower and extends to the “U shape junction.” The motor 8 is installed in the head 14. The top of the head is hitched by medical-use soft silicone rubber hitch 9. In addition, the motor 8 has a counterweight, which makes this stimulator have good stability during usage.

The rear part of the body 16 includes the upper cover 1, the lower cover 5 and the battery cover, which can be formed of medical-use soft silicone rubber 6 in which a battery 7, for example, a 1.5V, LR44 button-shape battery can be installed. The battery 7 is installed in the base of the battery cover of medical-use soft silicone rubber 6, through which the battery is installed in the body. The battery cover of the medical-use soft silicone rubber 6 fixes the battery firmly, thereby generating a waterproof effect as well. The cathode metal conductor 3 and the anode metal conductor 2 connect the cathode and anode of the battery respectively so that current is output to drive the dc motor.

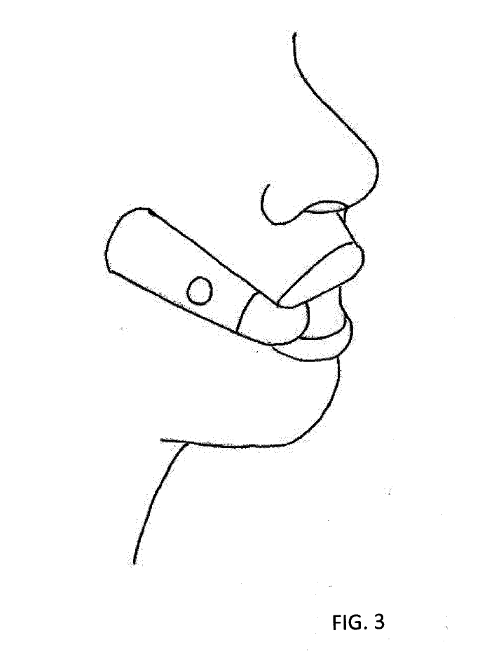

The motor 8 connects with the micro-circuit control chip as well. The micro-circuit control chip 4 controls the rotation output of the motor. Programming can be set to the micro-circuit control chip. The controlling motor has multiple different rotation output. FIG. 3 shows the state of use of the first embodiment of the present invention. As seen, this invention allows the user to wear on their mouth conveniently without affecting other motions.

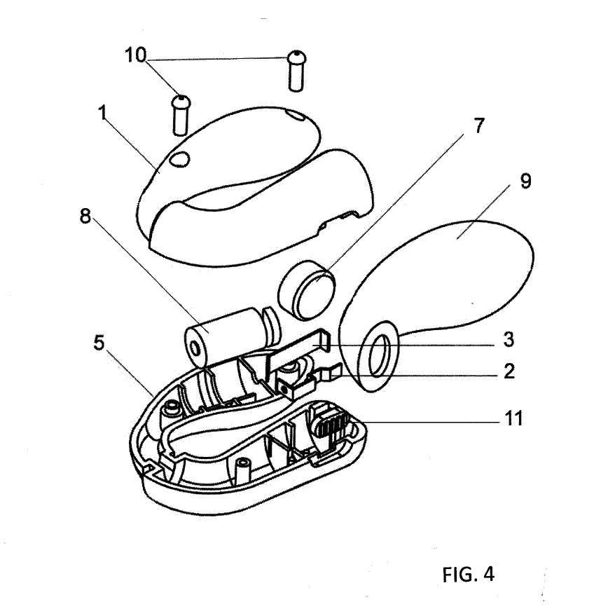

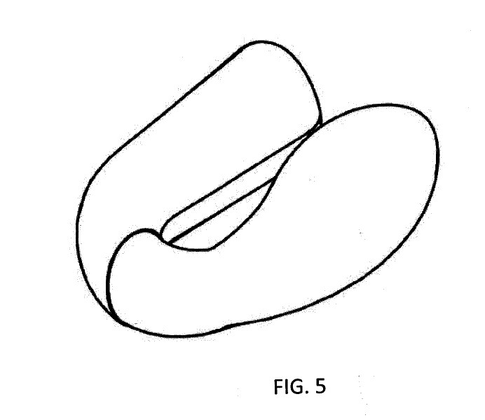

FIGS. 4 and 5 show a second embodiment, another advanced embodiment of the present invention. In contrast with the first embodiment, the overall body is in a “U” shape for this embodiment. It includes the upper cover 1 and lower cover 5. The area between the upper cover 1 and the lower cover 5 is fixed through the screw 10. A switch 11 controls the function of the motor.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A stimulator for oral sex comprising:
a motor; and
a body having a fore part and a rear part, wherein the body forms a clipping structure such that it is configured to be clipped onto and worn on a mouth of a user, and wherein the fore part of the body is configured to be put inside the mouth to snug a wall of a mouth cavity while the rear part of the body snugs an exterior of a face.

2. The stimulator for oral sex according to claim 1, wherein the body is in a U-shape, and wherein the fore part and the rear part are joined by a U-shape junction, a radius of which forms a clipping effect so that the stimulator is configured to be clipped onto and worn on the mouth.

3. The stimulator for oral sex according to claim 1, wherein the body is in a J-shape, wherein the fore part and the rear part are joined by a U-shape junction, a radius of which forms a clipping effect so that the stimulator is configured to be clipped onto and worn on the mouth.

4. The stimulator for oral sex according to claim 2, wherein the head of the fore part of the body is in an oval shape, wherein a side of the body is relatively flat in shape, and wherein the body becomes incrementally narrower and extends toward the U-shape junction.

5. The stimulator for oral sex according to claim 2, wherein the rear part of the body is formed by extending and expanding from the U-shape junction.

6. The stimulator for oral sex according to claim 1, wherein the body is hitched by a medical-use soft silicone rubber hitch.

7. The stimulator for oral sex according to claim 1, wherein the motor is installed in a head of the fore part of the body together with a counterweight.

8. The stimulator for oral sex according to claim 13, wherein the stimulator has batteries or rechargeable batteries as a source of power, both of which are installed at the rear part of the body.

9. The stimulator for oral sex according to claim 3, wherein a micro-circuit control chip is installed at the rear part of the body, and wherein the micro-circuit control chip controls the motor to form multiple output modes of rotation or vibration.
